(19) United States
(12) Patent Application Publication
(10) Pub. No.: US 2020/0290643 A1
(43) Pub. Date: Sep. 17, 2020

(54) VEHICLE CONTROL DEVICE, VEHICLE CONTROL METHOD, AND PROGRAM

(71) Applicant: HONDA MOTOR CO., LTD., Minato-ku, Tokyo (JP)

(72) Inventors: Yugo Ueda, Wako-shi (JP); Atsushi Arai, Tokyo (JP); Yuki Motegi, Tokyo (JP)

(21) Appl. No.: 16/650,395

(22) PCT Filed: Oct. 5, 2017
(86) PCT No.: PCT/JP2017/036282

§ 371 Date: Mar. 25, 2020

(51) Int. Cl. B60W 60/00; B60W 30/09; B60W 30/18; B60Q 1/50; B60W 10/20

(52) U.S. Cl. CPC B60W 60/0017; B60W 30/09; B60W 30/18163; B60W 2552/00; B60W 10/20; B60W 2554/4029; B60W 2554/4041; B60Q 1/50

(57) ABSTRACT

A vehicle control device includes a road width recognizer configured to recognize a width of a road on which a vehicle travels, a pedestrian recognizer configure to recognize pedestrians present in a vicinity of the vehicle, and a driving controller configured to cause the vehicle to travel by controlling one or both of steering and acceleration of the vehicle independently from an operation of an occupant of the vehicle, and to cause the vehicle to travel behind a pedestrian who has substantially the same proceeding direction as the vehicle and has a high priority level among the pedestrians recognized by the pedestrian recognizer when a width of the road recognized by the road width recognizer is equal to or less than a predetermined width.

### TECHNICAL FIELD

The present invention relates to a vehicle control device, a vehicle control method, and a program.

### BACKGROUND ART

In recent years, research on automatic control of vehicles has been conducted. In relation to this, a technology that acquires a future behavior in automated driving and notifies of the acquired future behavior to the outside of a vehicle is known (refer to Patent Literature 1).

### CITATION LIST

### Patent Literature

### [Patent Literature 1]

Japanese Unexamined Patent Application, First Publication No. 2017-4471

### SUMMARY OF INVENTION

### Technical Problem

However, in the conventional technology, the notification based on the future behavior in the automated driving of a vehicle is performed unilaterally to pedestrians and other vehicles in the vicinity, and driving control in a narrow road situation in which a vehicle is not able to pass a pedestrian unless the pedestrian moves to the side of a road has not been considered.

The present invention has been made in view of such circumstances, and an object thereof is to provide a vehicle control device, a vehicle control method, and a program which can perform appropriate driving control on the basis of a narrow road situation.

### Solution to Problem

(1): A vehicle control device (100) includes a road width recognizer (132) configured to recognize a width of a road on which a vehicle (a host vehicle M) travels, a pedestrian recognizer (134) configured to recognize pedestrians present in the vicinity of the vehicle; and a driving controller (136, 138, 142, 144, 160) configured to cause the vehicle to travel by controlling one or both of steering and acceleration/deceleration of the vehicle independently from an operation of an occupant of the vehicle, and to cause the vehicle to travel behind a pedestrian who has substantially the same proceeding direction as the vehicle and has a high priority level among the pedestrians recognized by the pedestrian recognizer when the width of the road recognized by the road width recognizer is equal to or less than a predetermined width.

(2): In (1), when it is not possible to pass the pedestrian who has substantially the same proceeding direction as the vehicle and has a high priority level among the pedestrians recognized by the pedestrian recognizer, the driving controller causes the vehicle to travel behind the pedestrian.

(3): In (1) or (2), the pedestrian having a high priority level is a pedestrian closest to the vehicle.

(4): In any one of (1) to (3), the pedestrian recognizer recognizes that the pedestrian has turned around after the driving controller has started control to cause the vehicle to travel behind the pedestrian, and the driving controller executes driving control to pass the pedestrian when the pedestrian recognizer recognizes that the pedestrian has turned around.

(5): In any one of (1) to (4), the pedestrian recognizer recognizes a position of the pedestrian in a width direction of a road on which the vehicle travels, and the driving controller, when the pedestrian recognized by the pedestrian recognizer moves closer to one side of the road in the width direction by a predetermined degree or more, executes driving control to pass the pedestrian from the other side.

(6): In (5), when there is an area in which the pedestrian has difficulty walking on the road on which the vehicle travels, the driving controller causes the vehicle to pass through the area under the driving control to pass the pedestrian.

(7): In (6), when the pedestrian recognizer recognizes that the pedestrian has turned around, the driving controller execute the driving control to pass the pedestrian by making an extra width secured for passing the pedestrian smaller than an extra width when the pedestrian has not turned around.

(8): In any one of (1) to (7), the vehicle control device further includes a projector (70) configured to project an image onto the road on which the vehicle travels, and a projection controller (180) configured to cause, when the pedestrian recognizer recognizes a pedestrian, an image prompting the pedestrian to move out of the way onto the road on which the vehicle travels.

(9): In (8), when the pedestrian recognizer recognizes the pedestrian has moved out of the way after the projector has projected the image prompting the pedestrian to move out of the way, the driving controller executes driving control to pass the pedestrian.

(10): A vehicle control method includes recognizing, by a road width recognizer, a width of a road on which a vehicle travels, recognizing, by a pedestrian recognizer, pedestrians present in the vicinity of the vehicle, and causing, by a driving controller, the vehicle to travel by controlling one or both of steering and acceleration/deceleration of the vehicle independently from an operation of an occupant of the vehicle, and causing the vehicle to travel behind a pedestrian who has substantially the same proceeding direction as the vehicle and has a higher priority level among the pedestrians recognized by the pedestrian recognizer when the width of the road recognized by the road width recognizer is equal to or less than a predetermined width.

(11): A program which causes a computer, which is mounted in a vehicle including a road width recognizer that recognizes a width of a road on which the vehicle travels, to recognize pedestrians present in the vicinity of the vehicle, cause the vehicle to travel by controlling one or both of steering and acceleration/deceleration of the vehicle independently from an operation of an occupant of the vehicle, and cause the vehicle to travel behind a pedestrian who has substantially the same proceeding direction as the vehicle and has a higher priority level among the recognized pedestrians when the recognized width of the road is equal to or less than a predetermined width.

### Advantageous Effects of Invention

According to (1) to (11), it is possible to perform appropriate driving control on the basis of a narrow road situation.

### BRIEF DESCRIPTION OF DRAWINGS

FIG. 1 is a configuration diagram of a vehicle system 1 using a vehicle control device according to an embodiment.

FIG. 2 is a functional configuration diagram of a first controller 120, a second controller 160, and a projection controller 180.

FIG. 3 is a diagram for describing processing of a passing possibility determiner 136.

FIG. 4 is a diagram for describing that a following driving controller 142 causes a host vehicle M to move to one side of a traveling path R1 and to perform following travel.

FIG. 5 is a diagram for describing processing of a passing driving controller 144.

FIG. 6 is a diagram for describing the processing of the passing driving controller 144 when it is estimated that there is a difficult walking area.

FIG. 7 is a diagram showing how a projection controller 180 causes an image indicating an area in which a pedestrian is allowed to walk to be projected onto the traveling path R1.

FIG. 8 is a diagram showing how the projection controller 180 causes an image indicating an area in which the host vehicle M travels to be projected onto the traveling path R1.

FIG. 9 is a flowchart which shows an example of processing executed by an automated driving controller 100 of the embodiment.

FIG. 10 is a diagram which shows an example of a hardware configuration of the automated driving controller 100 of the embodiment.

### DESCRIPTION OF EMBODIMENT

Hereinafter, embodiment of a vehicle control device, a vehicle control method, and a program of the present invention will be described. Note that description will be provided using an automated driving vehicle in the following description. Automated driving is causing a vehicle to travel by controlling one or both of steering and speed of the vehicle independently from an operation of an occupant. In addition, manual driving by the occupant may be performed on the automated driving vehicle. In the manual driving, a traveling drive force output device, a brake device, and a steering device of the vehicle to be described below are controlled in accordance with an amount of operation performed by a driving operator to be described below.

[Overall Configuration]

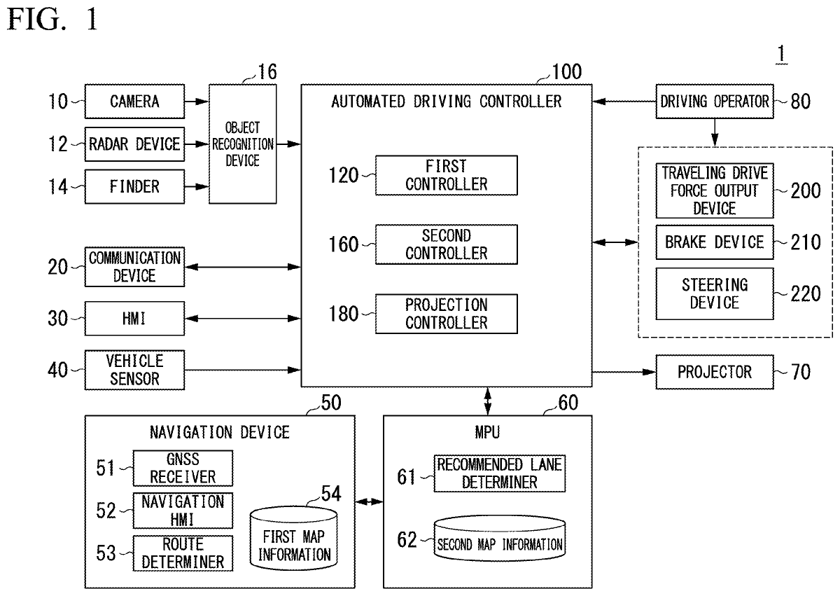

FIG. 1 is a configuration diagram of a vehicle system 1 using a vehicle control device according to an embodiment. A vehicle on which the vehicle system 1 is mounted is, for example, two-wheel, three-wheel, or four-wheel vehicle, and a driving source thereof is an internal combustion engine such as a diesel engine or a gasoline engine, an electric motor, or a combination thereof. When an electric motor is included, the electric motor operates using electric power generated by a generator connected to the internal combustion engine, or electric power discharged from a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a projector 70, a driving operator 80, an automated driving controller (an example of a vehicle control device) 100, a traveling drive force output device 200, a brake device 210, and a steering device 220. These devices or apparatuses are connected to each other by a multiplex communication line such as a controller area network (CAN) communicator line, a serial communication line, a wireless communication network, or the like. Note that the configuration shown in FIG. 1 is merely an example, and a part of the configuration may be omitted or another configuration may be added.

The camera 10 is, for example, a digital camera using a solid-state imaging device such as a charge coupled device (CCD) or a complementary metal oxide semiconductor (CMOS). One or a plurality of cameras 10 are attached to arbitrary places of a vehicle (hereinafter, referred to as a host vehicle M) on which the vehicle system 1 is mounted. When the front is imaged, the camera 10 is attached to an upper part of the front windshield, a back of the rearview mirror, or the like. The camera 10 periodically repeats to image a vicinity of the host vehicle M. The camera 10 may also be a stereo camera.

The radar device 12 radiates radio waves such as millimeter waves to the vicinity of the host vehicle M, and detects at least a position (a distance and an orientation) of an object by detecting radio waves (reflected waves) reflected by the object. One or a plurality of radar devices 12 are attached to arbitrary places of the host vehicle M. The radar device 12 may detect the position and a speed of the object using a frequency modulated continuous wave (FM-CW) method.

The finder 14 is a light detection and range (LIDAR). The finder 14 radiates light to the vicinity of the host vehicle M and measures scattered light. The finder 14 detects a distance to the object on the basis of time from light emission and light reception. The radiated light is, for example, pulsed laser light. One or a plurality of finders 14 are attached to arbitrary places of the host vehicle M.

The object recognition device 16 performs sensor fusion processing on a result of detection performed by some or all of the camera 10, the radar device 12, and the finder 14, and recognizes the position, type, speed, and the like of the object. The object recognition device 16 outputs a result of the recognition to the automated driving controller 100. In addition, the object recognition device 16 may output, when necessary, the results of detection by the camera 10, the radar device 12, and the finder 14 to the automated driving controller 100 as they are.

The communication device 20 uses, for example, a cellular network, a Wi-Fi network, a Bluetooth (a registered trademark), a dedicated short range communication (DSRC), or the like, and communicates with another vehicle present in the vicinity of the host vehicle M or communicates with various types of server devices via a radio base station.

The HMI 30 presents various types of information to an occupant of the host vehicle M and receives an input operation from the occupant. The HMI 30 includes various display devices, speakers, buzzers, touch panels, switches (for example, hazard switches), keys, and the like.

The vehicle sensor 40 includes a vehicle speed sensor that detects the speed of the host vehicle M, an acceleration sensor that detects the acceleration, a yaw rate sensor that detects an angular speed around a vertical axis, an orientation sensor that detects a direction of the host vehicle M, and the like.

The navigation device 50 includes, for example, a global navigation satellite system (GNSS) receiver 51, a navigation HMI 52, and a route determiner 53, and holds first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or supplemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route (hereinafter, a route on a map) from the position (or an arbitrary input position) of the host vehicle M identified by the GNSS receiver 51 to a destination input from the occupant using the navigation HMI 52 with reference to the first map information 54. The first map information 54 is, for example, information in which a road shape is expressed by a link indicating a road and a node connected by the link. The first map information 54 may include curvature of a road, point of interest (POI) information, and the like. A route on a map determined by the route determiner 53 is output to the MPU 60. In addition, the navigation device 50 may perform route guidance using the navigation HMI 52 on the basis of the route on a map determined by the route determiner 53. Note that the navigation device 50 may be realized by, for example, a function of a terminal device such as a smart phone or a tablet terminal owned by the occupant. Moreover, the navigation device 50 may transmit a current position and a destination to a navigation server via the communication device 20 and acquire a route on a map returned from the navigation server.

The MPU 60 functions as, for example, a recommended lane determiner 61, and holds second map information 62 in the storage device such as an HDD or a flash memory. The recommended lane determiner 61 divides the route provided from the navigation device 50 into a plurality of blocks (for example, divides every 100 [m] in a vehicle traveling direction), and determines a recommended lane for each block with reference to the second map information 62. The recommended lane determiner 61 determines which numbered lane to travel from the left. When there is a branch place, a merging place, or the like in the route, the recommended lane determiner 61 determines a recommended lane such that the host vehicle M may travel in a reasonable route for traveling to a branch destination.

The second map information 62 is map information with higher accuracy than the first map information 54. The second map information 62 includes, for example, information on a center of a lane or information on a boundary of the lane. In addition, the second map information 62 may include road information, traffic regulation information, address information (addresses/postal codes), facility information, telephone number information, and the like. The second map information 62 may be updated at any time by accessing another device using the communication device 20 communicating with another device.

The projector 70 is, for example, a projector. The projector 70 projects an image onto the traveling path of the host vehicle M at a timing instructed by the projection controller 180. The traveling path refers to an area in which the host vehicle M can travel. The traveling path may be a lane separated by a road section line, or may be a road on which a vehicle can travel without a road section line such as an alley. A sidewalk or the like that is sectioned from a roadway using steps, guardrails, or the like may not be included in the traveling path.

The driving operator 80 includes, for example, an accelerator pedal, a brake pedal, a shift lever, a steering wheel, a modified steer, a joystick, and other operators. A sensor that detects an operation amount or a presence or absence of an operation is attached to the driving operator 80, and this detection result is output to the automated driving controller 100 or the traveling drive force output device 200, and one or both of the brake device 210 and the steering device 220.

The automated driving controller 100 includes, for example, a first controller 120, a second controller 160, and a projection controller 180. The first controller 120, the second controller 160, and the projection controller 180 are realized, for example, by a hardware processor such as a central processing unit (CPU) executing a program (software). In addition, some or all of these components may be realized by hardware (a circuit; including circuitry) such as a large scale integration (LSI), an application specific integrated circuit (ASIC), a field-programmable gate array (FPGA), and a graphics processing unit (GPU), and may also be realized by a cooperation of software and hardware.

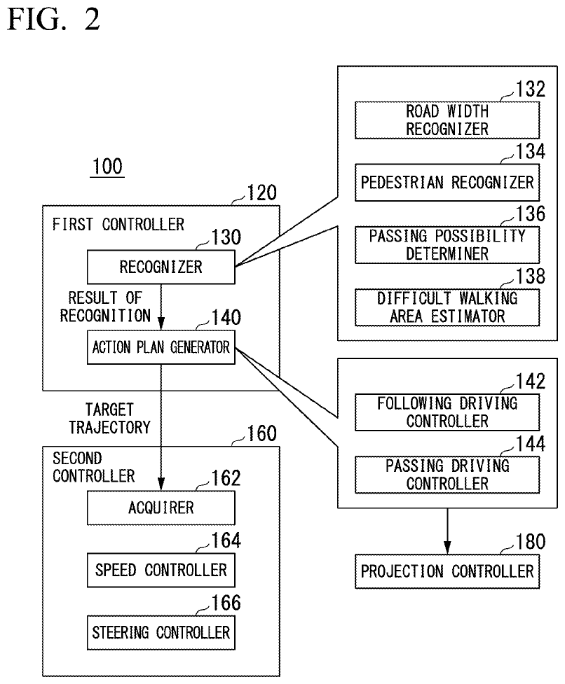

FIG. 2 is a functional configuration diagram of the first controller 120, the second controller 160, and the projection controller 180. The first controller 120 includes, for example, a recognizer 130 and an action plan generator 140. The recognizer 130 includes, for example, a road width recognizer 132, a pedestrian recognizer 134, a passing possibility determiner 136, and a difficult walking area estimator 138. The action plan generator 140 includes, for example, a following driving controller 142 and a passing driving controller 144. A combination of the passing possibility determiner 136, the difficult walking area estimator 138, the following driving controller 142, the passing driving controller 144, and the second controller 160 is an example of a “driving controller.”

The first controller 120 realizes, for example, a function based on artificial intelligence (AI) and a function based on a model given in advance in parallel. For example, a function of “recognizing an intersection” is realized by executing a recognition of an intersection by an image recognition method using deep learning or the like and a recognition based on conditions (including pattern matching signals, road markings, and the like) given in advance in parallel and comprehensively evaluating the both by scoring them. As a result, a reliability of automated driving is guaranteed.

The recognizer 130 recognizes situations such as the position, speed and acceleration of the object in the vicinity of the host vehicle M on the basis of information to be input from the camera 10, the radar device 12, and the finder 14 via the object recognition device 16. The object includes oncoming vehicles and stationary obstacles. The position of the object is, for example, recognized as a position on absolute coordinates having the origin at a representative point (a center of gravity, a center of a drive axis, or the like) of the host vehicle M, and is used for control. The position of the object may be represented by a representative point such as a center of gravity or a corner of the object, or may be represented by an expressed area. A “state” of the object may include the acceleration or jerk of the object, or an “action state” (for example, whether a lane is changed or is intended to be changed). In addition, the recognizer 130 recognizes a shape of a curve through which the host vehicle M will pass from now on the basis of an image captured by the camera 10. The recognizer 130 converts the shape of the curve from the image captured by the camera 10 into a real plane, and, for example, outputs two-dimensional point sequence information or information expressed using a model equivalent thereto to the action plan generator 140 as information indicating the shape of the curve.

In addition, the recognizer 130 recognizes, for example, a lane (traveling lane) in which the host vehicle M is traveling. For example, the recognizer 130 recognizes a traveling lane by comparing a pattern (for example, an array of solid lines and dashed lines) of a road section line obtained from the second map information 62 with a pattern of a road section line in the vicinity of the host vehicle M recognized from an image captured by the camera 10. Note that the recognizer 130 may recognize a traveling lane by recognizing not only a road section line but also a traveling road boundary (road boundary) including road section lines, road shoulders, curbs, median strips, guardrails, and the like. In this recognition, the position of the host vehicle M acquired from the navigation device 50 and a result of processing performed by the INS may be added. Moreover, the recognizer 130 recognizes temporary stop lines, road signs, red light, tollgates, or other road events.

When a traveling lane is recognized, the recognizer 130 recognizes the position and posture of the host vehicle M with respect to the traveling lane. The recognizer 130 may recognize, for example, a deviation of a reference point of the host vehicle M from a lane center and an angle formed with respect to a line connecting the lane centers in a traveling direction of the host vehicle M as the relative position and posture of the host vehicle M with respect to the traveling lane. In addition, instead, the recognizer 130 may recognize a position and the like of the reference point of the host vehicle M with respect to either side end (a road section line or a road boundary) of the traveling lane as the relative position of the host vehicle M with respect to the traveling lane.

In addition, the recognizer 130 may derive recognition accuracy and output it to the action plan generator 140 as recognition accuracy information in the recognition processing described above. For example, the recognizer 130 generates the recognition accuracy information on the basis of a frequency at which a road section line can be recognized in a certain period. Functions of the road width recognizer 132, the pedestrian recognizer 134, the passing possibility determiner 136, and the difficult walking area estimator 138 of the recognizer 130 will be described below.

In principle, the action plan generator 140 travels on a recommended lane determined by the recommended lane determiner 61, and furthermore, is sequentially executed in automated driving to cope with a vicinity situation of the host vehicle M. Functions of the following driving controller 142 and the passing driving controller 144 of the action plan generator 140 will be described below.

The second controller 160 includes, for example, an acquirer 162, a speed controller 164, and a steering controller 166. The acquirer 162 acquires information on the target trajectory (trajectory points) generated by the action plan generator 140 and stores it in a memory (not shown). The speed controller 164 controls the traveling drive force output device 200 or the brake device 210 on the basis of a speed element associated with the target trajectory stored in the memory. The steering controller 166 controls the steering device 220 in accordance with a bending of the target trajectory stored in the memory. Processing of the speed controller 164 and the steering controller 166 is realized by, for example, a combination of feed forward control and feedback control. As an example, the steering controller 166 executes a combination of the feed forward control in accordance with curvature of a road in front of the host vehicle M and the feedback control based on a deviation from the target trajectory.

The projection controller 180 causes the projector 70 to project an image indicating a target trajectory along which the host vehicle M will travel in the future, which is generated by the action plan generator 140, the following driving controller 142, or the passing driving controller 144 on a traveling path of the host vehicle M. Details of functions of the projection controller 180 will be described below.

The traveling drive force output device 200 outputs a traveling drive force (torque) for a traveling of a vehicle to drive wheels. The traveling drive force output device 200 includes, for example, a combination of an internal combustion engine, an electric motor, a transmission, and the like, and an ECU that controls these. The ECU controls the constituents described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure to the cylinder, and a brake ECU. The brake ECU controls the electric motor according to the information input from the second controller 160 or the information input from the driving operator 80 such that a brake torque corresponding to a braking operation is output to each wheel. The brake device 210 may include, as a backup, a mechanism that transmits the hydraulic pressure generated by an operation of the brake pedal included in the driving operator 80 to the cylinder via a master cylinder. Note that the brake device 210 is not limited to the configuration described above, and may be an electronically controlled hydraulic brake device that controls an actuator according to the information input from the second controller 160 and transmits the hydraulic pressure of the master cylinder to the cylinder.

The steering device 220 includes, for example, a steering ECU and an electric motor. The electric motor changes a direction of the steering wheel by, for example, applying a force to a rack and pinion mechanism. The steering ECU drives the electric motor and changes the direction of the steering wheel according to the information input from the second controller 160 or the information input from the driving operator 80.

[Function of Road Width Recognizes]

The road width recognizer 132 recognizes a road width of a traveling path on which the host vehicle M travels. For example, the road width recognizer 132 recognizes road section lines on left and right sides as viewed from the position of the host vehicle M from the image captured by the camera 10 and recognizes a distance between the recognized left and right road section lines as a width of a road. In addition, the road width recognizer 132 may collate the position of the host vehicle M with the first map information 54 or the second map information 62, and recognize a width of a road on which the host vehicle M travels.

[Function of Pedestrian Recognizer]

The pedestrian recognizer 134 recognizes pedestrians present in the vicinity of the host vehicle M. For example, the pedestrian recognizer 134 may operate when a road width recognized by the road width recognizer 132 is equal to or less than a predetermined width (for example, about 4 m or less). In addition, the pedestrian recognizer 134 may also operate when the host vehicle M is traveling on a road whose width is narrower than a national road or a prefectural road, or on a road on which pedestrians are likely to walk.

The pedestrian recognizer 134 recognizes the presence of a pedestrian on a traveling path in a proceeding direction (hereinafter referred to as the front) of the host vehicle M from the image captured by the camera 10. In addition, the pedestrian recognizer 134 recognizes a position, a moving speed, and a moving direction of the pedestrian. Moreover, the pedestrian recognizer 134 may recognize a relative position, a relative speed, and a relative moving direction of a pedestrian viewed from the host vehicle M.

[Function of Passing Possibility Determiner]

The passing possibility determiner 136 determines whether the host vehicle M can pass a pedestrian on the basis of the position of the pedestrian recognized by the pedestrian recognizer 134, shapes and sizes of the host vehicle M and the traveling path, and the like.

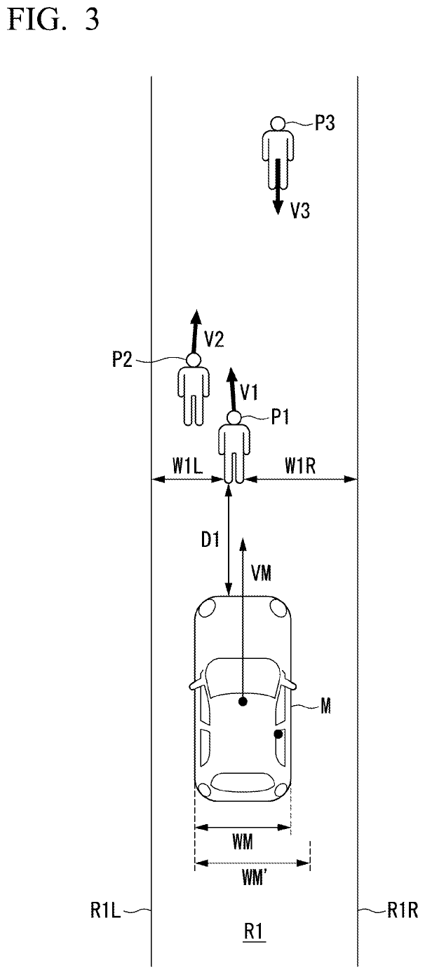

FIG. 3 is a diagram for describing processing of the passing possibility determiner 136. In the example of FIG. 3, pedestrians P1 to P3 are present in front of the host vehicle M traveling on a traveling path RE The host vehicle M travels at a speed VM in the proceeding direction, and the pedestrians P1 and P2 each move at speeds V1 and V2 in substantially the same direction as the proceeding direction of the host vehicle M. Substantially the same direction includes not only the same direction as the proceeding direction of the host vehicle M but also a predetermined error range (for example, about −15 [degrees] to 15 [degrees]). In addition, a pedestrian P3 is an oncoming pedestrian walking at a speed V3 in opposition to the host vehicle M. The positions and speeds V1 to V3 of the pedestrians P1 to P3 are recognized by the pedestrian recognizer 134.

The passing possibility determiner 136 determines whether it is possible to perform passing in order from a pedestrian closest to the host vehicle M. The passing possibility determiner 136 calculates a distance W1L from the position of the pedestrian P1 to a left end R1L of the traveling path R1 and a distance W1R from the position of the pedestrian P1 to a right end R1R for the pedestrian P1 closest to the host vehicle M. Then, the passing possibility determiner 136 determines whether the host vehicle M can pass beside the pedestrian P1 on the basis of the vehicle width WM of the host vehicle M and the calculated distance W1L and W1R.

For example, the passing possibility determiner 136 determines that the host vehicle M cannot pass the pedestrian P1 when a width WM′ obtained by adding a predetermined extra width (margin) to a vehicle width WM is greater than the distances W1L and W1R. The extra width is a width secured for the host vehicle M to pass beside the pedestrian P1, and is, for example, about 0.3 [m]. In addition, the passing possibility determiner 136 determines that the host vehicle M can pass the pedestrian P1 when the width WM′ is equal to or less than the distances W1L and W1R.

The passing possibility determiner 136 also performs the same processing as the processing of determining passing possibility performed on the pedestrian P1 on pedestrians P2 and P3. Note that, since the pedestrian P3 is an oncoming pedestrian, it is predicted that the pedestrian visually recognizes the host vehicle M immediately and avoids it. Therefore, the passing possibility determiner 136 may not perform the processing of determining passing possibility for the pedestrian P3.

In addition, when the passing possibility determiner 136 determines that it is not possible to pass the pedestrian P1 closest to the host vehicle M, the pedestrians P2 and P3 further ahead cannot be passed. Accordingly, when it is determined that the pedestrian P1 closest to the host vehicle M cannot be passed among a plurality of pedestrians recognized by the pedestrian recognizer 134, the passing possibility determiner 136 may determine that the pedestrians P2 and P3 further ahead cannot be passed.

[Function of Following Driving Controller]

When the road width of the traveling path R1 recognized by the road width recognizer 132 is equal to or less than a predetermined width (for example, about 3.5 [m]), the following driving controller 142 causes the host vehicle M to travel behind a pedestrian who has substantially the same proceeding direction as the host vehicle M and has a high priority level among the pedestrians P1 to P3 recognized by the pedestrian recognizer 134. The pedestrian with a high priority level is, for example, a pedestrian closest to the host vehicle M. For example, the following driving controller 142 generates a target trajectory whose proceeding direction is substantially the same as the host vehicle M and that the host vehicle M travels behind the pedestrian P1 closest to the host vehicle M in a situation in which the passing possibility determiner 136 determines that the host vehicle M cannot pass the pedestrian.

In the example shown in FIG. 3, when the passing possibility determiner 136 determines that the vehicle cannot pass the pedestrian P1, the pedestrian recognizer 134 recognizes a relative distance D1 between the host vehicle M and the pedestrian P1. The following driving controller 142 generates a target trajectory in which the speed VM of the host vehicle M is changed on the basis of the relative distance and the speed V1 of the pedestrian P1. Specifically, the following driving controller 142 generates the target trajectory such that a speed difference between the traveling speed VM of the host vehicle M and the speed V1 of the pedestrian P1 is within a predetermined speed (for example, about ±3 [km/h]), and an error of the relative distance D1 is within a predetermined distance (for example, about ±3 [m]). As a result, the following driving controller 142 can cause the host vehicle M to follow the pedestrian P1 while maintaining a relative distance from the pedestrian P1 to some extent. In this manner, the host vehicle M is caused to follow the pedestrian P1, and thereby the presence of the host vehicle M can be noticed by the pedestrian P1 and the host vehicle can be moved to a road side.

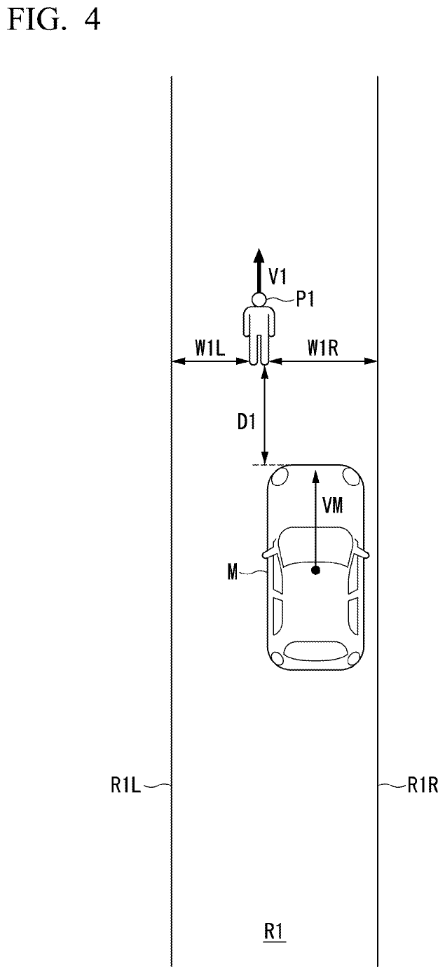

In addition, when the host vehicle M follows the pedestrian P1, the following driving controller 142 may move the host vehicle M to a side on which the pedestrian P1 can be passed to follow the pedestrian P1. FIG. 4 is a diagram for describing that the following driving controller 142 causes the host vehicle M to perform following travel by moving to one side of the traveling path RE In the following description, control for the pedestrian P1 will be described for convenience of description, but when a pedestrian who is proceeding in substantially the same direction ahead of the host vehicle M is replaced with another pedestrian, the same processing will be performed for the pedestrian.

The following driving controller 142 compares the distance W1L from the position of the pedestrian P1 and the left road side R1L and the distance W1R from the position of the pedestrian P1 to the right road side R1R, and causes the host vehicle M to perform following travel by moving it to the side of the road where the distance is longer.

In the example of FIG. 4, since the distance W1R is longer than the distance W1L, the following driving controller 142 causes the host vehicle M to move to the right side of the traveling path R1 to follow the pedestrian P1. As a result, when the pedestrian P1 has recognized the presence of the host vehicle M, the pedestrian can easily move to the left side of the traveling path RE

[Function of Passing Driving Controller]

When it is determined that the position of the pedestrian P1 recognized by the pedestrian recognizer 134 is moved to one side of the traveling path R1 in the width direction by a predetermined degree or more, the passing driving controller 144 generates a target trajectory for passing the pedestrian P1 from the other side. To move to one side in the width direction by a predetermined degree or more means, for example, that the position of the pedestrian P1 is within a predetermined distance (for example, about 0.5 [m]) from one side of the road of the traveling path R1. By moving to one side in the width direction by a predetermined degree of more, a distance from the position of the pedestrian P1 to the other road side of the traveling path R1 becomes larger than the width WM′.

However, when the pedestrian P1 turns around to a side of the host vehicle M after the following driving controller 142 has started driving control to follow the pedestrian P1, the passing driving controller 144 may generate a target trajectory for passing the pedestrian P1 even if the position of the pedestrian P1 is not moved to one side of the traveling path R1 in the width direction by a predetermined degree or more.

For example, the pedestrian recognizer 134 determines whether the pedestrian P1 has turned around on the basis of a behavior of the head or upper body imaged in the image captured by the camera 10. Specifically, when feature information (for example, eyes or mouth) of the face of the pedestrian P1 can be recognized from the image captured by the camera 10 mounted on the host vehicle M traveling behind the pedestrian P1, the pedestrian recognizer 134 determines that the pedestrian P1 has turned around.

In addition, when the eyes of the pedestrian P1 are recognized from the captured image, the pedestrian recognizer 134 recognizes a gaze direction based on a positional relationship between an inner corner and an iris of the recognized eyes. Then, the pedestrian recognizer 134 may determine that the pedestrian P1 has turned around when the recognized gaze direction is a direction in which the host vehicle M is present.

In addition, the pedestrian recognizer 134 may estimate a rotation angle of the head from the image captured by the camera 10 and determine that the pedestrian P1 has turned around when the estimated rotation angle of the head is equal to or larger than a predetermined angle (for example, about 90 [degrees]) based on the proceeding direction of the pedestrian P1. In this case, the pedestrian recognizer 134 estimates, for example, the rotation angle of the head on the basis of a displacement in position of the feature information (for example, the ear) of the head obtained from the image captured by the camera 10.

Moreover, the pedestrian recognizer 134 may estimate a rotation angle of the upper body of the pedestrian P1 instead of (or in addition to) the rotation angle of the head of the pedestrian P1, and determine that the pedestrian P1 has turned around when the estimated rotation angle of the upper body is equal to or larger than a predetermined angle (for example, about 90 [degrees]).

The passing possibility determiner 136 determines that the pedestrian P1 can be passed when the pedestrian recognizer 134 recognizes that the pedestrian has turned around.

The passing driving controller 144 generates a target trajectory for passing the pedestrian P1 when the passing possibility determiner 136 determines that the host vehicle M can pass the pedestrian P1.

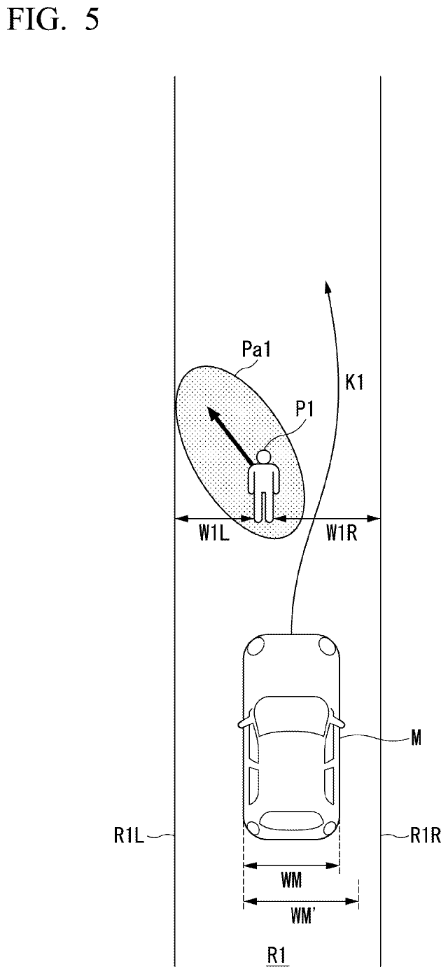

FIG. 5 is a diagram for describing processing of the passing driving controller 144. The passing driving controller 144 predicts the position, moving speed, and moving direction of the pedestrian P1 after turning around, and sets a target potential area Pal on the basis of a result of the prediction. A target potential is, for example, an index indicating a height of possibility of the host vehicle M coming into contact with a target (for example, a pedestrian). In addition, the target potential area is set to have a lower target potential as a distance from a target increases.

In the example of FIG. 5, the passing driving controller 144 predicts that the pedestrian P1 will move to the left road side R1L closer to a roadside among the left road side R1L and the right road side R1R after turning around to allow the host vehicle M to pass, and predicts the position of the pedestrian P1 after a predetermined time on the basis of a current position, a moving speed, and a moving direction of the pedestrian P1. Then, the passing driving controller 144 generates a target trajectory K1 passing through an area that is not in contact with the target potential area Pal. Note that following driving by the following driving controller 142 is executed in parallel until passing driving control along the target trajectory K1 generated by the passing driving controller 144 is executed.

In addition, the passing driving controller 144 determines whether the distance W1R between the pedestrian P1 and the right road side R1R of the traveling path R1 is larger than the width WM′ after the target trajectory K1 is generated. In addition, when the pedestrian recognizer 134 recognizes that the pedestrian P1 has turned around, the passing driving controller 144 may estimate that the pedestrian can recognize the presence of the host vehicle M, set the extra width added to the vehicle width WM smaller than the extra width when the pedestrian P1 has not turned around (for example, about 0.15 [m]), determine whether it is possible to pass the pedestrian P1, and the like.

When the distance W1R is not equal to or less than the width WM′, the passing driving controller 144 continues following driving by the following driving controller 142 without executing passing driving along the target trajectory K1. In addition, the passing driving controller 144 executes passing driving of the host vehicle M along the target trajectory K1 when the distance W1R is larger than the width WM′.

[Function of Difficult Walking Area Estimator]

The difficult walking area estimator 138 estimates an area in which pedestrians have difficulty walking on the traveling path R1. A difficult walking area is an area in which pedestrians can walk, but it is estimated that shoes or clothes of the pedestrians get wet or dirty by walking through that area, and that pedestrians are more likely to fall. Difficult walking areas include, for example, puddle areas, areas whose road surfaces are frozen, or areas whose road surfaces are uneven.

The difficult walking area estimator 138 estimates a puddle area, a frozen area, or an uneven area by comparing luminance information of a road surface of the traveling path R1 from the image captured by the camera 10 with luminance information of a reference road surface. In addition, the difficult walking area estimator 138 may acquire a shape of a road surface from the image captured by the camera 10 and estimate that pedestrians have difficulty walking when a degree of unevenness of the road surface is equal to or greater than a predetermined reference degree.

When a target trajectory for passing a pedestrian is generated and an area in which pedestrians have difficulty walking on the traveling path R1 is estimated, the passing driving controller 144 generates the target trajectory such that the host vehicle M passes through the area in which pedestrians are estimated to have difficulty walking.

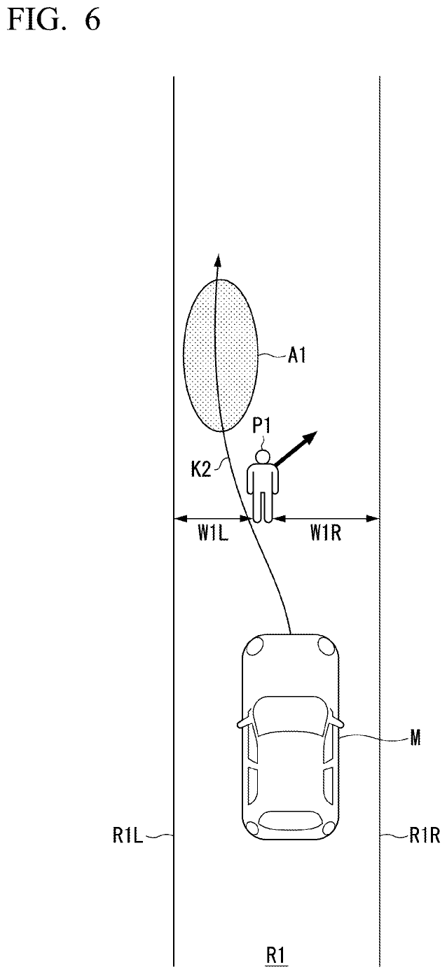

FIG. 6 is a diagram for describing the processing of the passing driving controller 144 when it is estimated that there is a difficult walking area. In the example of FIG. 6, a puddle area A1 is shown on the traveling path R1. When the difficult walking area estimator 138 estimates that there is the puddle area A1, the passing driving controller 144 generates a target trajectory K2 for passing the pedestrian P1 by causing the host vehicle M to pass through the area A1. As a result, the pedestrian P1 can move to an area other than the puddle area A1 in which the pedestrian can easily avoid the host vehicle M.

[Function of Projection Controller]

When the pedestrian recognizer 134 recognizes a pedestrian, the projection controller 180 causes the projector 70 to project an image prompting the pedestrian to avoid the host vehicle M onto the traveling path R1. The image prompting the pedestrian to avoid the host vehicle M may be, for example, an image indicating a direction in which the pedestrian can avoid the host vehicle M or may also be an image indicating an area in which the host vehicle M will travel.

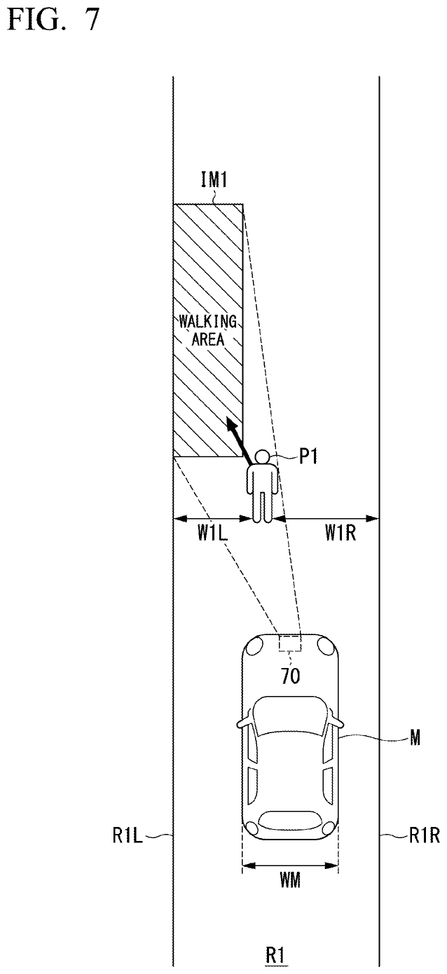

FIG. 7 is a diagram showing how the projection controller 180 causes an image indicating an area in which a pedestrian is allowed to walk to be projected onto the traveling path RE When there is no road width to pass the pedestrian P1 and the host vehicle M travels behind the pedestrian P1, the following driving controller 142 generates an image IM1 for causing the pedestrian P1 to move to the left road side R1L, and causes the projector 70 to project the generated image IM1 onto a predetermined area in front of the pedestrian P1, which is on the left road side R1L of the traveling path RE The predetermined area in the front is an area which is included in a range of several [m] away from a current position of the pedestrian P1 and is easy for the pedestrian P1 to visually recognize while walking.

The positional image IM1 of the pedestrian may be, for example, an image indicating an area, may be an image including text such as “walking area,” or may be a combination thereof. It is possible to allow the pedestrian P1 to easily ascertain a walking area that is not affected when the host vehicle M passes through by projecting text information such as “walking area.” In addition, the projection controller 180 causes the image IM1 to be projected, thereby allowing the pedestrian P1 to ascertain to which position he or she can move.

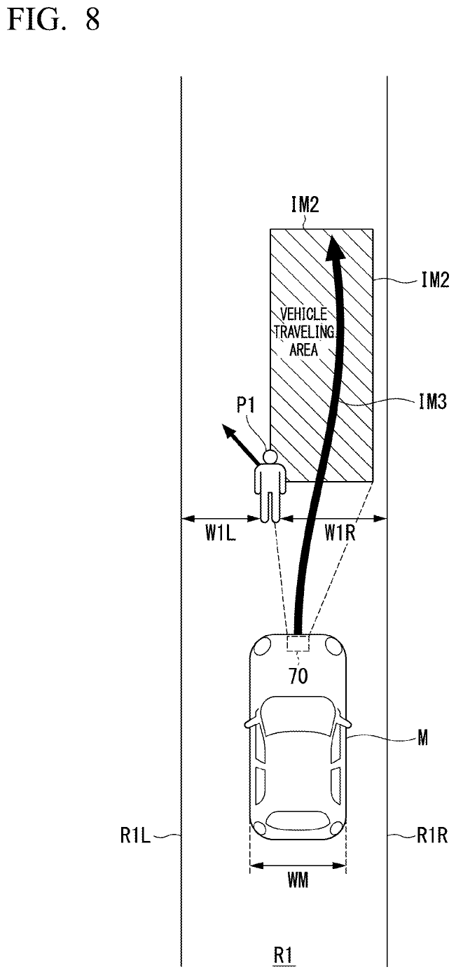

FIG. 8 is a diagram showing how the projection controller 180 causes an image indicating an area in which the host vehicle M will travel to be projected onto the traveling path RE In the example of FIG. 8, the projection controller 180 causes the projector 70 to project one or both of an image IM2 indicating a traveling area of the host vehicle M and an image IM3 indicating the target trajectory onto the traveling path R1 on the basis of the target trajectory K1 generated by the passing driving controller 144. The image IM2 may be, for example, an image indicating an area, may be an image including text such as “vehicle traveling area,” or may be a combination thereof. By projecting text information such as “vehicle traveling area,” it is possible to allow the pedestrian P1 to easily ascertain an area through which the host vehicle M passes, and to prompt the pedestrian to move to an area other than the vehicle traveling area. In addition, the projection controller 180 may change colors or patterns of the images IM1 to IM3 to be projected or may display an animation corresponding to the images IM1 to IM3 on the basis of a driving condition such as weather or a time zone.

The projection controller 180 causes the images IM1 to IM3 to be projected, thereby allowing the pedestrian P1 to quickly move to a road side on the traveling path R1. The passing driving controller 144 executes driving control to pass the pedestrian P1 when the pedestrian recognizer 134 recognizes that the pedestrian P1 has moved to the side after at least one of the images IM1 to IM3 is projected by the projection controller 180. The projection controller 180 ends the projection of the images IM1 to IM3 after, for example, the host vehicle M has passed the pedestrian P1.

[Processing Flow]

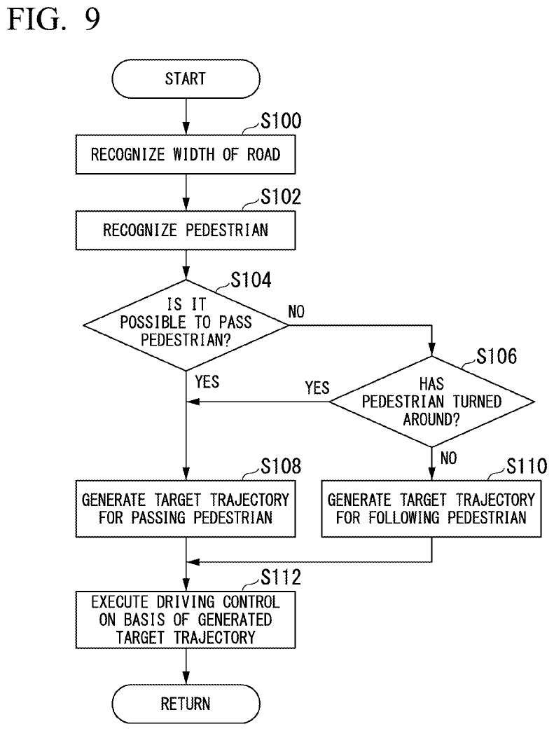

FIG. 9 is a flowchart which shows an example of processing executed by an automated driving controller 100 of the embodiment. Processing of this flowchart may be repeatedly executed, for example, at a predetermined cycle or predetermined timing while automated driving of the host vehicle M is executed.

First, the road width recognizer 132 recognizes the road width of the traveling path R1 on which the host vehicle M travels (step S100). Next, the pedestrian recognizer 134 recognizes a pedestrian in front of the host vehicle M on the traveling path R1 on which the host vehicle M travels (step S102). Next, the passing possibility determiner 136 determines whether it is possible to pass the pedestrian on the basis of the road width of the traveling path R1 recognized by the road width recognizer 132 and the position of the pedestrian recognized by the pedestrian recognizer 134 (step S104). For example, when the road width of the traveling path R1 is equal to or less than a predetermined width and it is determined that it is not possible to pass the pedestrian, the pedestrian recognizer 134 determines whether the pedestrian has turned around (step S106).

When it is determined that it is possible to pass the pedestrian in the processing of step S104, or when the pedestrian has turned around in the processing of step S106, the passing driving controller 144 generates a target trajectory for passing the pedestrian (step S108). In addition, when the pedestrian has not turned around in step S106, the following driving controller 142 generates a target trajectory for following, for example, a pedestrian who proceeds in substantially the same direction as the host vehicle M and has a high priority level (for example, closest to the host vehicle M) (step S110). Next, the second controller 160 executes driving control on the basis of the generated target trajectory (step S112). With this, the processing of this flowchart ends.

Note that, when a target trajectory is generated in the processing of step S108 or S110 described above, the passing driving controller 144 or the following driving controller 142 may generate the target trajectory in consideration of a result of the estimation by the difficult walking area estimator 138. In addition, when the driving control is executed in the processing of step S112 described above, the second controller 160 may cause the projector 70 to project an image prompting the pedestrian to avoid the host vehicle M.

According to the embodiment described above, the width of a road on which the host vehicle M travels is recognized, pedestrians present in the vicinity of the host vehicle M are also recognized, and when the recognized width of a road is equal to or less than a predetermined width, the host vehicle M is caused to travel behind a pedestrian who has substantially the same proceeding direction as the host vehicle M and has a high priority level among the recognized pedestrians, and thereby it is possible to perform appropriate driving control in a road situation in which the vehicle cannot pass the pedestrian if the pedestrian does not move to a road side.

[Hardware Configuration]

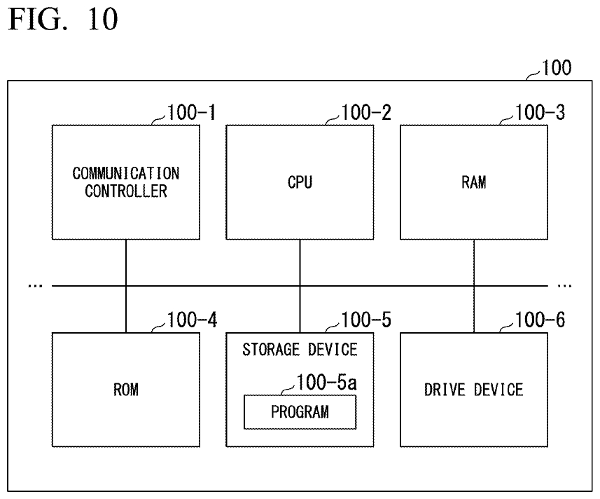

The automated driving controller 100 of the embodiment described above is, for example, realized by a configuration of hardware as shown in FIG. 10. FIG. 10 is a diagram which shows an example of a hardware configuration of the automated driving controller 100 of the embodiment.

The automated driving controller 100 is configured to include a communication controller 100-1, a CPU 100-2, a RAM 100-3, a ROM 100-4, a secondary storage device 100-5 such as a flash memory or an HDD, and a drive device 100-6 connected to each other by an internal bus or a dedicated communication line. A portable storage medium such as an optical disc is mounted in the drive device 100-6. The first controller 120 and the second controller 160 are realized by a DMA controller (not shown) expanding a program 100-5a stored in the secondary storage device 100-5 in the RAM 100-3 and the CPU 100-2 executing it. In addition, a program to which the CPU 100-2 refers may be stored in a portable storage medium mounted in the drive device 100-6, or may be downloaded from another device via the network NW.

The embodiment described above can be expressed as follows.

A vehicle control device is configured to include a storage device configured to store information, and a hardware processor configured to execute a program stored in the storage device, in which the hardware processor executes the program, thereby executing road width recognition processing for recognizing a width of a road on which a vehicle travels, pedestrian recognition processing for recognizing pedestrians present in the vicinity of the vehicle, and driving control processing for causing the vehicle to travel by controlling one or both of steering and acceleration of the vehicle independently from an operation of an occupant of the vehicle, and causing the vehicle to travel behind a pedestrian who has substantially the same proceeding direction as the vehicle and has a high priority level among the pedestrians recognized by the pedestrian recognizer when the width of the road recognized in the road width recognition processing is equal to or less than a predetermined width.

A mode for implementing the present invention has been described using the embodiment. However, the present invention is not limited to this embodiment, and various modifications and substitutions may be made within a range not departing from the gist of the present invention.

### REFERENCE SIGNS LIST

1 Vehicle system
10 Camera
12 Radar device
14 Finder
16 Object recognition device
20 Communication device
30 HMI
32 Automated driving start switch
40 Vehicle sensor
50 Navigation device
60 MPU
70 Projector
80 Driving operator
100 Automated driving controller
120 First controller
130 Recognizer
132 Road width recognizer
134 Pedestrian recognizer
136 Passing possibility determiner
138 Difficult walking area estimator
140 Action plan generator
142 Following driving controller
144 Passing driving controller
160 Second controller
180 Projection controller

What is claim is:

1.-11. (canceled)

12. A vehicle control device comprising:
a road width recognizer configured to recognize a width of a road on which a vehicle travels;
a pedestrian recognizer configured to recognize pedestrians present in a vicinity of the vehicle; and
a driving controller configured to cause the vehicle to travel by controlling one or both of steering and acceleration of the vehicle independently from an operation of an occupant of the vehicle, and to cause the vehicle to travel behind a pedestrian who has substantially the same proceeding direction as the vehicle among the pedestrians recognized by the pedestrian recognizer when a width of the road recognized by the road width recognizer is equal to or less than a predetermined width.

13. The vehicle control device according to claim 12,
wherein, when the width of the road recognized by the road width recognizer is equal to or less than a predetermined width, the driving controller causes the vehicle to follow a pedestrian who has substantially the same proceeding direction as the vehicle and has a high priority level among the pedestrians recognized by the pedestrian recognizer.

14. The vehicle control device according to claim 13,
wherein, when it is not possible to overtake the pedestrian who has substantially the same proceeding direction as the vehicle and has a high priority level among the pedestrians recognized by the pedestrian recognizer, the driving controller causes the vehicle to travel behind the pedestrian.

15. The vehicle control device according to claim 13,
wherein the pedestrian having a high priority level is a pedestrian closest to the vehicle.

16. The vehicle control device according to claim 12,
wherein the pedestrian recognizer recognizes that the pedestrian has turned around after the driving controller has started control to cause the vehicle to travel behind the pedestrian, and
the driving controller executes driving control to overtake the pedestrian when the pedestrian recognizer recognizes that the pedestrian has turned around.

17. The vehicle control device according to claim 12,
wherein the pedestrian recognizer recognizes a position of the pedestrian in a width direction of a road on which the vehicle travels, and
the driving controller, when a pedestrian recognized by the pedestrian recognizer moves closer to one side of the road in the width direction by a predetermined degree or more, executes driving control to overtake the pedestrian from the other side.

18. The vehicle control device according to claim 17,
wherein, when there is an area in which the pedestrian has difficulty walking on a road on which the vehicle travels, the driving controller causes the vehicle to pass through the area under driving control to overtake the pedestrian.

19. The vehicle control device according to claim 18,
wherein, when the pedestrian recognizer recognizes that the pedestrian has turned around, the driving controller execute driving control to overtake the pedestrian by making an extra width secured for overtaking the pedestrian smaller than an extra width when the pedestrian does not turn around.

20. The vehicle control device according to claim 12, further comprising:
a projector configured to project an image onto a road on which the vehicle travels; and
a projection controller configured to cause, when the pedestrian recognizer recognizes a pedestrian, an image prompting the pedestrian to avoid onto the road on which the vehicle travels.

21. The vehicle control device according to claim 20,
wherein, when the pedestrian recognizer recognizes the pedestrian has avoided after the projector has projected an image prompting the pedestrian to avoid, the driving controller executes driving control to overtake the pedestrian.

22. A vehicle control method comprising:
recognizing, by a road width recognizer, a width of a road on which a vehicle travels;
recognizing, by a pedestrian recognizer, pedestrians present in a vicinity of the vehicle; and
causing, by a driving controller, the vehicle to travel by controlling one or both of steering and acceleration of the vehicle independently from an operation of an occupant of the vehicle, and, when the width of the road recognized by the road width recognizer is equal to or less than a predetermined width, causing the vehicle to travel behind a pedestrian who has substantially the same proceeding direction as the vehicle among the pedestrians recognized by the pedestrian recognizer.

23. A non-transitory computer-readable storage medium that stores a program to be executed by a vehicle computer to perform at least:
recognize a width of a road on which the vehicle travels;
recognize pedestrians present in a vicinity of the vehicle;
cause the vehicle to travel by controlling one or both of steering and acceleration of the vehicle independently from an operation of an occupant of the vehicle; and
cause the vehicle to travel behind a pedestrian who has substantially the same proceeding direction as the vehicle among the recognized pedestrians when the recognized width of the road is equal to or less than a predetermined width.
